(19) United States
(12) Patent Application Publication
(10) Pub. No.: US 2019/0233121 A1
(43) Pub. Date: Aug. 1, 2019

(54) LIFE VEST BAG

(71) Applicant: RECARO Aircraft Seating GmbH & Co. KG, Schwaebisch Hall (DE)

(72) Inventors: Melissa WUNDERLICH, Oehringen (DE); Markus WIELAND, Sittenhardt (DE); Georg ROLLBUEHLER, Crailsheim (DE)

(21) Appl. No.: 16/097,915

(22) PCT Filed: Feb. 8, 2017
(86) PCT No.: PCT/EP2017/052761

§ 371 Date: Mar. 21, 2019

(30) Foreign Application Priority Data
May 4, 2016 (DE) 10 2016 108 288.0

(51) Int. Cl. B64D 11/06; B63C 9/08; B65D 33/16; B65D 33/25

(52) U.S. Cl. CPC B64D 11/0631; B63C 9/08; B63C 9/23; B65D 33/2508; B63C 9/081; B65D 33/1691

(57) ABSTRACT

A life vest bag, in particular a passenger seat life vest bag, has at least one receiving unit, which comprises at least one receiving space for at least one life vest and at least one access opening to the receiving space, and has at least one closure unit which closes the access opening in at least one correctly closed state.

### PRIOR ART

The invention relates to a life vest bag according to the preamble of claim 1.

EP 1 901 958 A1 discloses a life vest bag for an aircraft seat having a hinged lid which closes a storage chamber for a life vest. In addition, US 2015/0 034 641 A1, for example, discloses a life vest bag for an aircraft seat having a drawstring by means of which a life vest is able to be removed, when necessary, from the life vest bag by a passenger.

The object of the invention consists, in particular, in providing a generic life vest bag with advantageous properties with regard to a design. The object is achieved according to the invention by the features of claim 1, whilst advantageous designs and further developments of the invention are able to be taken from the subclaims.

### Advantages of the Invention

The invention relates to a life vest bag, in particular to a passenger seat life vest bag, for example an aircraft seat life vest bag, having at least one receiving unit which comprises at least one receiving space for at least one life vest and at least one access opening to the receiving space, and having at least one closure unit which closes the access opening in at least one correctly closed state.

A life vest bag is to be understood, in particular, as a container for storing at least, preferably precisely, one life vest, in particular for a passenger and/or a driver of a vehicle, for example of a ship or a boat or a motor vehicle, in particular of a bus, or of a rail vehicle or an aircraft. In particular, the life vest is an inflatable life vest, for example with at least one gas pressure cartridge which is configured for inflating at least one float. In particular, the life vest is arranged in a stowed state at least in part, preferably entirely, in the receiving space. The life vest is advantageously folded and/or compressed and/or packed in the stowed state. The term “configured” is to be understood, in particular, as especially designed and/or equipped. An object being configured for a certain function is to be understood, in particular, as the object meeting and/or carrying out said certain function in at least one application and/or operating state.

The closure unit and the receiving unit are advantageously connected to one another so as to be captive, for example in an articulated manner. As an alternative to this or in addition to it, it is conceivable for the closure unit and the receiving unit to be connected to one another by means of at least one connection element. In particular, the connection element can be realized as a cord and/or a line and/or a tape.

In an open state, the life vest can preferably be removed from the receiving space, in particular through the access opening, without any damage. The life vest, at least in the stowed state, and the access opening preferably comprise an at least substantially identical cross section. A first object and a second object comprising an “at least substantially identical cross section” is to be understood, in this case, in particular, as a minimum surface area of a differential surface, which is formed when the cross sections are placed one on top of the other, being a maximum of 20%, advantageously a maximum of 10% and particularly advantageously a maximum of 5% of the surface area of the larger of the two cross sections for at least one cross section of the first object and at least one arbitrary cross section of the second object. It is also possible, however, for a cross section of the life vest and a cross section of the access opening to differ.

In the correctly closed state, the access opening and/or a region of the access opening which is uncovered and/or unclosed, in particular by the seal, advantageously comprises a cross section which is smaller than a cross section of the life vest in the stowed state, in particular parallel to the access opening. In particular, the life vest is arranged in the receiving space so as to be inaccessible in the correctly closed state. A cross section of an object, which, in the correctly closed state, is insertable into the receiving space in a damage-free manner and/or without damaging the closure unit and the receiving unit as well as, in particular, the seal, is advantageously a maximum of 2 cm² or a maximum of 1 cm² or a maximum of 0.5 cm² and in a preferred manner a maximum of 9 mm by 9 mm. A length of an object, which, in the correctly closed state, is insertable into the receiving space in a damage-free manner and/or without damaging the closure unit and the receiving unit, is preferably a maximum of 99 mm, in a particularly preferred manner a maximum of 50 mm. It is conceivable for the access opening, in the correctly closed state, to comprise the same cross section as in the open state. It is conceivable, in particular, for the closure unit to cover and/or to span and/or to overlap the access opening in the correctly closed state at least in part, advantageously entirely.

An advantageous construction method can be provided, in particular, by the design according to the invention.

In addition, advantageous properties with regard to a low weight and/or to rapid and/or cost-efficient production and/or to a reduced variety of parts can be obtained in particular. In addition, a high degree of operational reliability and/or a high level of operating comfort can be obtained. In an advantageous manner, maintenance that is simple and/or quick to carry out is made possible. In particular, a life vest bag which is easily fillable and/or can easily be tested for a correct state can be provided.

The life vest bag advantageously comprises at least one seal which is configured for the purpose of indicating the correctly closed state. In particular, the seal is configured to be damaged at least in part when the access opening is opened. The seal preferably comprises at least one closure which is configured for fixing, in particular mechanically, a state of the closure unit in the correctly closed state. For example, the seal can comprise at least one adhesive seal and/or at least one adhesive film and/or at least one plastic film and/or at least one lead seal and/or at least one bolt and/or at least one pin and/or at least one split pin. It is conceivable for the seal to be connected in one piece to the closure unit. As a result, it is possible to recognize a correct and/or an incorrect state of the life vest bag quickly and/or reliably.

A further design of the invention proposes that the life vest bag comprises at least one, in particular the, seal which is configured to be at least damaged when an object, which comprises a cross section with a cross-sectional area of more than 2 cm², in an advantageous manner of more than 1 cm² and in a particularly advantageous manner of more than 9 mm by 9 mm, is pushed into the receiving space. As a result, it is possible to avoid inserting larger objects and/or potential damage or destruction of a life vest.

An advantageous design of the invention proposes that a cross section of the access opening in the correctly closed state deviates from a cross section of the access opening in the open state. In particular, a cross section of the access opening in the correctly closed state is smaller than in the open state. The closure unit is preferably configured for the purpose of deforming the receiving unit, in particular the access opening, in the closed state at least in part. For example, the receiving unit can be realized at least in part, advantageously entirely, as a sack and/or a bag and in particular can be realized so as to be deformable in a damage-free manner. Structural simplicity can be advantageously made possible as a result. Furthermore, tight and/or complete closing can be made possible as a result. In addition, space-saving geometry can be provided in an advantageous manner.

A particularly advantageous design of the invention proposes that the closure unit comprises at least two closure elements which close the access opening in the correctly closed state. The closure elements are preferably connected to one another, in particular at least in pairs, advantageously in a captive manner, in particular in the correctly closed state and/or in the open state. In particular, in the event of opening, a connection between the closure element is released at least in part, for example on at least one side of the closure element. In particular, the closure elements can be connected to one another integrally. It is conceivable for the closure elements, in particular in a state when connected to one another, to be configured for the purpose of deforming the access opening at least in part. A more reliable closure and/or a mechanism which is simple to operate and/or is more reliable can be advantageously provided as a result.

A preferred design of the invention proposes that the closure elements are connected to one another in an articulated manner, in particular at least in pairs. The closure elements preferably realize a frame encompassing the access opening at least in part. For example, the closure elements can each realize part of a joint. It is, in particular, conceivable for the closure elements to be connected to one another by means of a film hinge and advantageously integrally. However, it is also conceivable for the closure unit to comprise at least one articulated element which connects the closure elements together in an articulated manner, preferably at least in pairs. A high level of operating comfort and/or simple handling and/or a high level of reliability can be obtained as a result.

A particularly preferred design of the invention proposes that in the correctly closed state the closure elements are connected to one another by means of at least one positive locking connection, in particular a latching connection. The closure elements are preferably connected to one another along at least one first side, in particular in an articulated manner. In a particularly advantageous manner, the closure elements are connected by means of the positive locking connection along at least one second side. In an advantageous manner, at least one of the connecting elements comprises at least one latching lug and in particular realizes the same. The closure unit preferably comprises at least one actuating element which is connected in particular to at least one of the closure elements, advantageously integrally, and is configured for the release of the positive locking connection by a user. A more reliable and/or solid and/or where required easily releasable connection can be provided advantageously as a result. In addition, simple opening is made possible advantageously as a result.

It is further proposed that the closure unit comprises at least one spring element which is configured for supporting, at least in part, an opening of the access opening. In particular, the spring elements can be realized as a helical spring or as a spiral spring or as a leaf spring or as a leg spring or as a conical spring, for example produced from a metal and/or a plastics material. The spring element can be a compression spring or a tensile spring. It is conceivable for at least one closure element of the closure unit to realize the spring element. It is additionally conceivable for the spring element to be connected, in particular integrally, to the receiving unit. The term “integrally” is to be understood, in particular, as being connected at least in a substance-to-substance bond, for example by means of a welding process, a gluing process, an injection process and/or another process which appears sensible to the expert, and/or is molded advantageously in one piece, such as, for example, as a result of production from a casting and/or as a result of production using a single or multiple component injection method and advantageously from one single blank. The spring element is preferably arranged between the closure elements. The spring element advantageously generates compressive forces which act on the closure elements and act in different, in particular opposite, directions. In a particularly advantageous manner, the spring element, in at least one operating state, in particular during opening, presses the closure elements in different directions, in particular apart from one another. Easy access to a life vest can be made possible in an advantageous manner as a result. This means, in particular, that a life vest is easily able to be removed, where necessary, by a nervous and/or excited and/or unfocused and/or distracted user.

The spring element is realized advantageously as a spring hinge encompassing the access opening at least in part, particularly advantageously entirely. By a first object “encompassing at least in part” a second object is to be understood, in particular, that there is at least one projection direction for which at least 80%, advantageously at least 90% and particularly advantageously 95% of the points of a projection of the second object lie inside a smallest convex polygon which encloses a projection of the first object. In particular, the spring hinge can comprise a first spring hinge piece and a second spring hinge piece which are connected to one another in a flat manner at least in portions, advantageously on two opposite sides of the access opening. The spring hinge preferably realizes an edge of the access opening, at least in portions, in a preferred manner entirely. The closure unit advantageously comprises at least one clamping element which deforms the spring hinge at least in part in the correctly closed state. In a particularly advantageous manner, the clamping element compresses the spring hinge in the correct state, as a result of which, in particular, the access opening is closed. The spring hinge is preferably connected integrally to the receiving unit. A small variety of parts and/or a simple design and/or a low weight can be advantageously achieved as a result.

An advantageous design of the invention proposes that the closure unit is fastened to the receiving unit by means of at least one clamping connection, in particular in a region of the access opening. A “clamping connection” is to be understood, in particular, as a connection at least by means of a positive locking closure and/or a non-positive locking closure. For example, the receiving unit can be clamped between the connection elements. As a result, structural simplicity and/or space-saving geometry can be advantageously obtained. In addition, advantageous characteristics with regard to a cost-efficient and/or simple and/or rapid production can be obtained as a result.

A particularly advantageous design of the invention proposes that at least a portion of the closure unit, preferably the entire closure unit, is realized so as to be removable from the receiving unit. In particular, with the closure unit in a removed state, the closure unit and the receiving unit are arranged in a contact-free manner. However, it is also conceivable, as mentioned above in particular, for the closure unit to be connected to the receiving unit by means of a connection element. In an advantageous manner, the closure unit is realized so as to be removable and/or separable from the receiving unit. In a particularly advantageous manner, the closure unit is configured for the purpose releasing the access opening at least in part, preferably completely, when the closure unit is removed from the receiving unit. Easy access to a life vest can be obtained advantageously as a result.

A preferred design of the invention proposes that the closure unit is connected integrally to the receiving unit. In particular, the receiving unit and the closure unit are realized at least in part, preferably entirely, from a plastics material and/or from a fabric. The receiving unit and the closure unit are preferably realized from at least one common, in particular curved and/or folded, plate and/or from at least one film, in particular from a plastics material. However, it is also conceivable for the receiving unit and the closure unit to be realized from metal, for example from at least one, in particular curved and/or folded metal sheet. Simple production can be made possible advantageously as a result, in particular without any need for sewing.

A further design of the invention proposes that the closure unit is fastened to the receiving unit by means of at least one zipper. One side of the zipper is preferably part of the closure unit. In a particularly preferred manner, a further side of the zipper is part of the receiving unit. In particular, the zipper runs along an edge of the access opening. The further side of the zipper preferably realizes the access opening at least in part, preferably to at least a large extent. The term “at least to a large extent” is to be understood, in this case, in particular, as at least to 55%, advantageously at least to 65%, preferably at least to 75%, particularly preferred at least to 85% and particularly advantageously to at least to 95%. As a result, a life vest can advantageously be maintained and/or replaced, in particular without breaking the seal.

It is additionally proposed that the seal comprises at least two adhesive strips and at least one sealing strip which is glued onto the adhesive strip. An “adhesive strip” is to be understood, in this case, in particular, as a plastics material strip which comprises advantageous adhesive properties. The adhesive strips are preferably all formed from the same material. The adhesive strips are preferably formed from a hard plastics material. In principle, it is also conceivable for an adhesive strip on the one side of the access opening to be formed preferably from a different material to the adhesive strip arranged on the opposite side of the access opening. In this case, the two different adhesive strips are preferably formed from variously hard plastics material, the adhesive strip formed from a harder plastics material preferably increasing the stability of the life vest bag, whilst the adhesive strip formed from a softer plastics material comprises more advantageous properties for when the sealing strip is released. The adhesive strips, in this case, are preferably formed from a polycarbonate, a polyvinyl chloride (PVC) or from another plastics material that appears sensible to the expert. As a result, advantageous sealing of the access opening can be provided and the access opening can be, in particular, advantageously completely closed and insertion of objects without breaking the seal can be advantageously prevented. Advantageous specifications can be maintained in particular as a result.

In addition, a system having a life vest bag according to the invention and having at least one life vest arranged in the receiving space is proposed. A shape of the life vest and/or a type of collapsing and/or of folding the life vest is preferably adapted to the life vest bag. In a particularly preferred manner, with the life vest in a stowed state, a volume of the life vest corresponds at least substantially to a volume of the receiving space. The term “at least substantially” is to be understood in this context, in particular, as a deviation from a predefined value corresponding in particular to less than 15%, preferably to less than 10% and particularly preferred to less than 5% of the predefined value.

An advantageous design can be obtained, in particular, with a passenger seat, preferably an aircraft seat, with a life vest bag according to the invention. In particular, the passenger seat can comprise the system.

The life vest bag according to the invention is not to be restricted, in this connection, to the above-described application and embodiment. In particular, for fulfilling a functionality described herein, the life vest bag according to the invention can comprise a number which deviates from the number of individual elements, components and units named herein.

### DRAWINGS

Further advantages are produced from the following description of the drawings. Nine exemplary embodiments of the invention are shown in the drawings. The drawings, the description and the claims include numerous features in combination. The expert will also look at the features individually in an expedient manner and combine them to form sensible further combinations.

The drawings are as follows:

FIG. 1 shows a schematic side view of a passenger seat with a first life vest bag,

FIG. 2 shows a perspective representation of the first life vest bag in a correctly closed state,

FIG. 3 shows a perspective representation of the first life vest bag in an open state,

FIG. 4 shows a perspective representation of a second life vest bag in a correctly closed state,

FIG. 5 shows a perspective representation of the second life vest bag in an open state,

FIG. 6 shows a perspective representation of a third life vest bag,

FIG. 7 shows a schematic top view of a fourth life vest bag,

FIG. 8 shows a schematic representation of a closure unit of the fourth life vest bag,

FIG. 9 shows a schematic sectional representation of the closure unit of the fourth life vest bag,

FIG. 10 shows a schematic representation of a fifth life vest bag,

FIG. 11 shows a schematic representation of the fifth life vest bag in a correctly closed state,

FIG. 12 shows a schematic representation of a sixth life vest bag,

FIG. 13 shows a schematic representation of a seventh life vest bag in a correctly closed state,

FIG. 14 shows a schematic representation of the seventh life vest bag in an open state,

FIG. 15 shows a perspective representation of an eighth life vest bag,

FIG. 16 shows a perspective representation of a ninth life vest bag,

FIG. 17 shows a perspective representation of a tenth life vest bag,

FIG. 18 shows a perspective representation of an eleventh life vest bag and

FIG. 19 shows a further perspective representation of the life vest bag.

### DESCRIPTION OF THE EXEMPLARY EMBODIMENTS

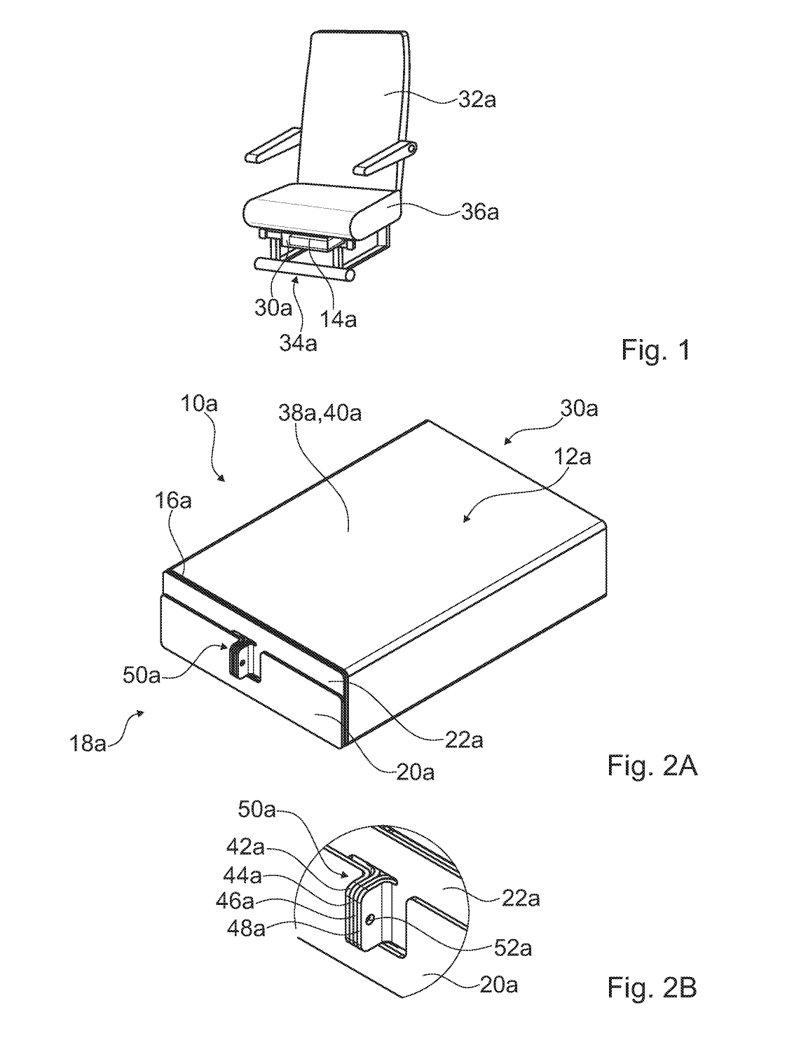

FIG. 1 shows a schematic side view of a passenger seat 32a having a system 34a which comprises a first life vest bag 30a and a life vest 14a. The life vest bag 30a is mounted below a sitting surface 36a of the passenger seat 32a. In the present case, the passenger seat 32a is realized as an aircraft seat. In principle, it is also conceivable for a life vest bag to be mounted on a panel or a leg support.

FIG. 2 shows a perspective representation of the first life vest bag 30a in a correctly closed state.

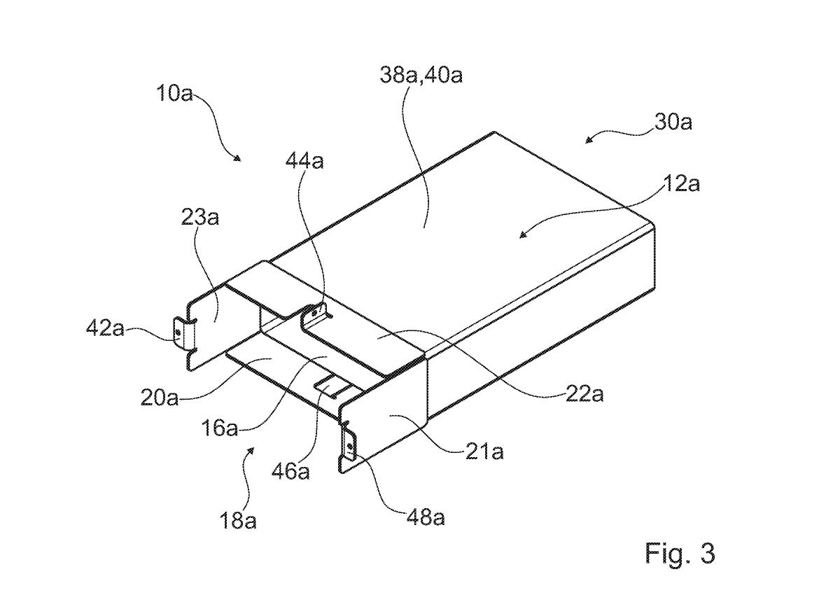

FIG. 3 shows the first life vest bag 30a in an open state. The first life vest bag 30a comprises a receiving unit 10a and a closure unit 18a. The receiving unit 10a comprises a receiving space 12a and an access opening 16a to the receiving space 12a. The closure unit 18a closes the access opening 16a in the correctly closed state.

In the present case, the receiving unit 10a comprises a housing 38a. The housing 38a comprises a folded plastics material plate 40a which realizes the housing 38a at least in part. Instead of the plastics material plate, however, it is also possible to have a plate-like object produced from a deviating material which comprises, for example, a fabric and/or a metal and in particular additionally plastics material.

The closure unit 18a comprises a first closure element 20a and a second closure element 22a which close the access opening 16a in the correctly closed state. In addition, the closure unit 18a comprises a third closure element 21a and a fourth closure element 23a. In the present case, the first closure element 20a is realized as a plastics material flap. The first closure element 20a is connected to the receiving unit 10a. The first closure element 20a is welded to the housing 38a of the receiving unit 10a, in particular by means of ultrasound welding or for example by means of laser welding or, for example, by means of laser welding. It is also conceivable for a closure element to be connected integrally to a receiving unit. For example, a receiving unit and at least one closure element can be bent and/or formed from one common plastics material plate or one common metal sheet.

The second closure element 22a is realized analogously to the first closure element 20a and is connected to the receiving unit 10a. The first closure element 20a and the second closure element 22a form a top and a bottom closure flap. In addition, the third closure element 21a and the fourth closure element 23a form lateral closure flaps. The closure elements 20a, 21a, 22a, 23a comprise multiple tabs 42a, 44a, 46a, 48a which realize a common closing element 50a in the correctly closed state. The closing element 50a comprises a pass-through 52a which passes through each of the tabs 42a, 44a, 46a, 48a. The life vest bag 30a can be sealed in the correctly closed state by means of the pass-through 52a. In a sealed state, for example a sealing wire of a lead seal passes through the pass-through 52a. The lead seal is destroyed in this case on opening.

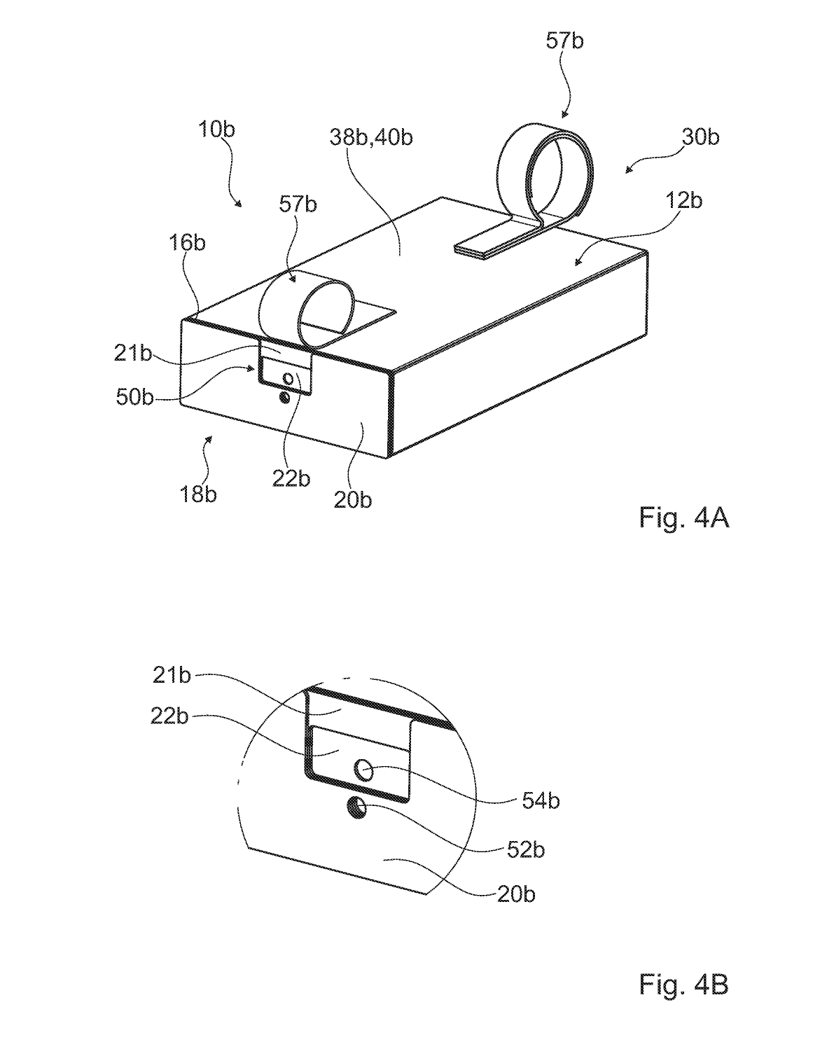

FIGS. 4 to 19 show ten further exemplary embodiments of the invention. The following descriptions and the drawings are limited substantially to the differences between the exemplary embodiments, it being possible, in principle, also to refer to the drawings and/or to the description of the other exemplary embodiments, in particular of FIGS. 1 to 3, with reference to identically designated components, in particular with reference to components with identical reference symbols. To differentiate between the exemplary embodiments, the letter a is placed after the reference symbols of the exemplary embodiment in FIGS. 1 to 3. In the exemplary embodiments in FIGS. 4 to 19, the letter a is replaced by the letters b to k.

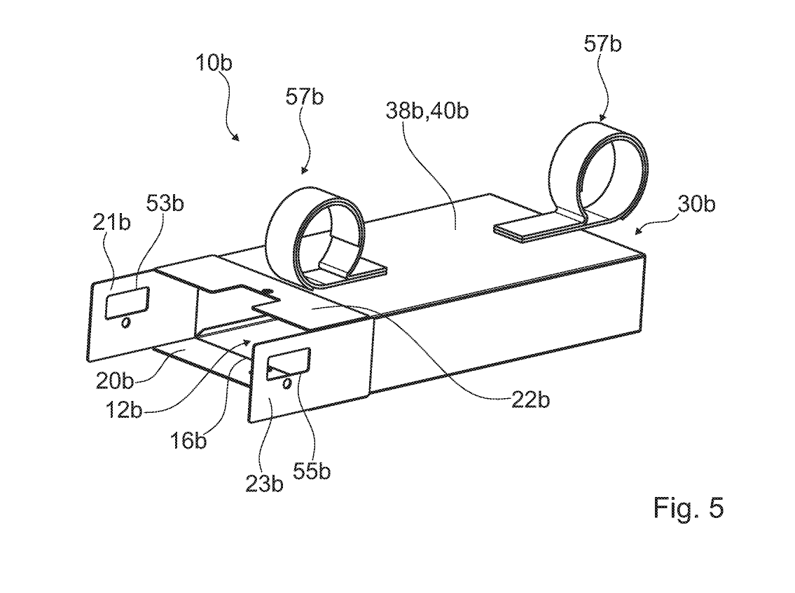

FIG. 4 shows a perspective representation of a second life vest bag 30b in a correctly closed state. FIG. 5 shows the second life vest bag 30b in an open state. The second life vest bag 30b comprises a receiving unit 10b and a closure unit 18b. The receiving unit 10b comprises a receiving space 12b and an access opening 16b to the receiving space 12b. The closure unit 18b closes the access opening 16b in the correctly closed state. The life vest bag 30b comprises a mounting unit 57b which is configured for mounting on a passenger seat, in particular on a frame structure of the passenger seat.

The closure unit 18b is connected integrally to the receiving unit 10a. The closure unit 18b comprises a first closure element 20b and a second closure element 22b. In addition, the closure unit 18b comprises a third closure element 21b and a fourth closure element 23b. The first closure element 20b is connected integrally to the receiving unit 10b. The first closure element 20b is realized as a plastics material flap. The second closure element 22b is realized analogously to the first closure element 20b and is fastened on the receiving unit 10b. The first closure element 20b and the second closure element 22b form a top and a bottom closure flap. In addition, the third closure element 21b and the fourth closure element 23b form lateral closure flaps.

The first closure element 20b comprises a first pass-through 52b. In addition, the third closure element 21b and the fourth closure element 23b comprise pass-throughs 53b, 55b. In the correctly closed state, the pass-throughs 52b, 53b, 55b are arranged one behind another and realize one common pass-through. The second closure element 22b comprises a second pass-through 54b. The third closure element 21b and the fourth closure element 23b comprise reach-throughs 25b, 26b, through which the second pass-through 54b is accessible in the correctly closed state. The life vest bag 30b can be sealed in the correctly closed state by means of the pass-throughs 52b, 53b, 54b, 55b. In a sealed state, for example a sealing wire of a lead seal or another seal passes through the pass-throughs 52a, 53b, 54a, 55b. The lead seal/the seal is destroyed on opening.

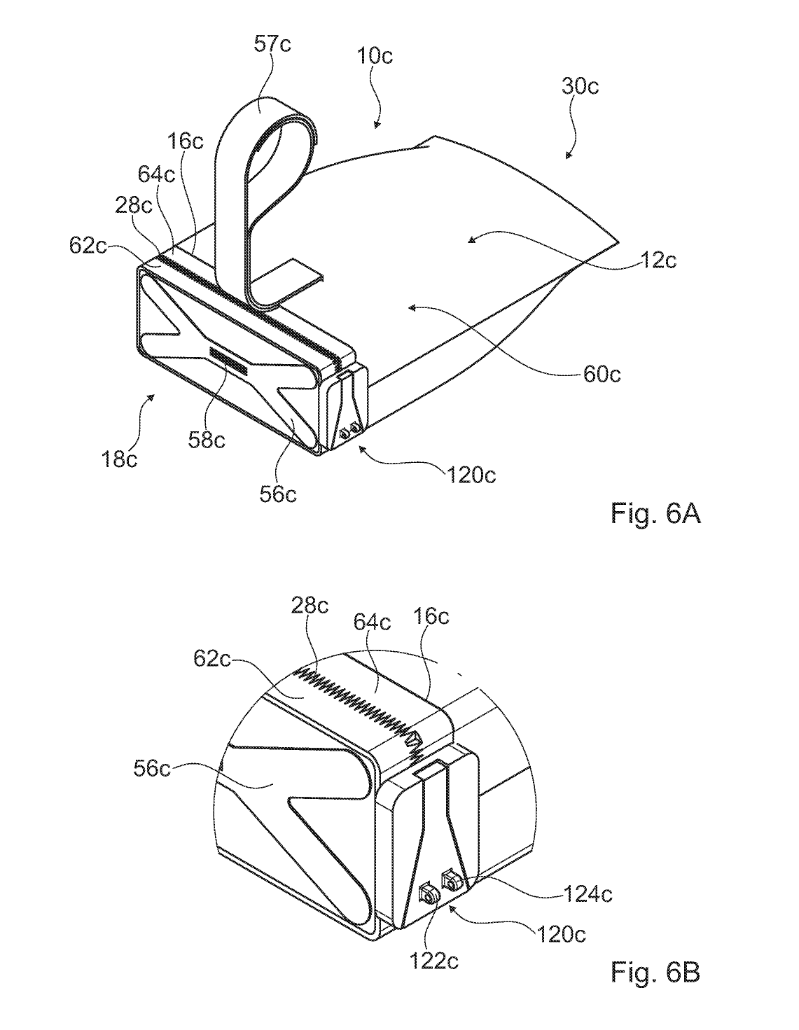

FIG. 6 shows a perspective representation of a third life vest bag 30c in a correctly closed state. The third life vest bag 30c comprises a receiving unit 10c and a closure unit 18c. The receiving unit 10c comprises a receiving space 12c and an access opening 16c to the receiving space 12c. The closure unit 18c closes the access opening 16c in the correctly closed state. The life vest bag 30c comprises a mounting unit 57c which is configured for mounting on a passenger seat, in particular on a frame structure of the passenger seat. The receiving unit 10c comprises a bag 60c which realizes the receiving space 12c.

The closure unit 18c comprises a seal 56c. The seal 56c is realized as a plastics material film. As an alternative to this or in addition to it, the seal can comprise a predetermined breaking point and/or an, in particular slitted, adhesive seal. The seal 56c is configured to be damaged or destroyed when a life vest is removed. The closure unit 18c comprises a slit 58c, through which a drawstring, which is in particular fastened to the life vest, is passable. For removal of the life vest from the receiving space 12c, a user can pull the life vest out of the receiving space 12c by the drawstring. In particular, the seal 56c is at least damaged when the life vest is pulled out of the receiving space.

The seal 56c is configured to be at least damaged when an object, which comprises a cross section with a cross-sectional area of more than 9 mm by 9 mm, is pushed into the receiving space 12c.

The closure unit 18c is fastened to the receiving unit 10c by means of a zipper 28c. A first zipper 62c of the zipper 28c is part of the closure unit 18c. A second zipper 64c of the zipper 28c is part of the receiving unit 10c. The second zipper 64c is connected to the bag 60c of the receiving unit 10c, in particular is sewn to the bag 60c. Opening the zipper 28cc allows a life vest to be maintained and/or replaced, the seal 56c remaining intact.

The zipper 28c is sealed by means of a zipper seal 120c. The zipper seal 120c comprises two eyelets 122c, 124c, through which a seal and/or a sealing wire can be passed to form a seal. The zipper seal 120c is configured for the purpose of indicating a correctly closed state of the zipper 28c and/or an unauthorized opening of the zipper 28c.

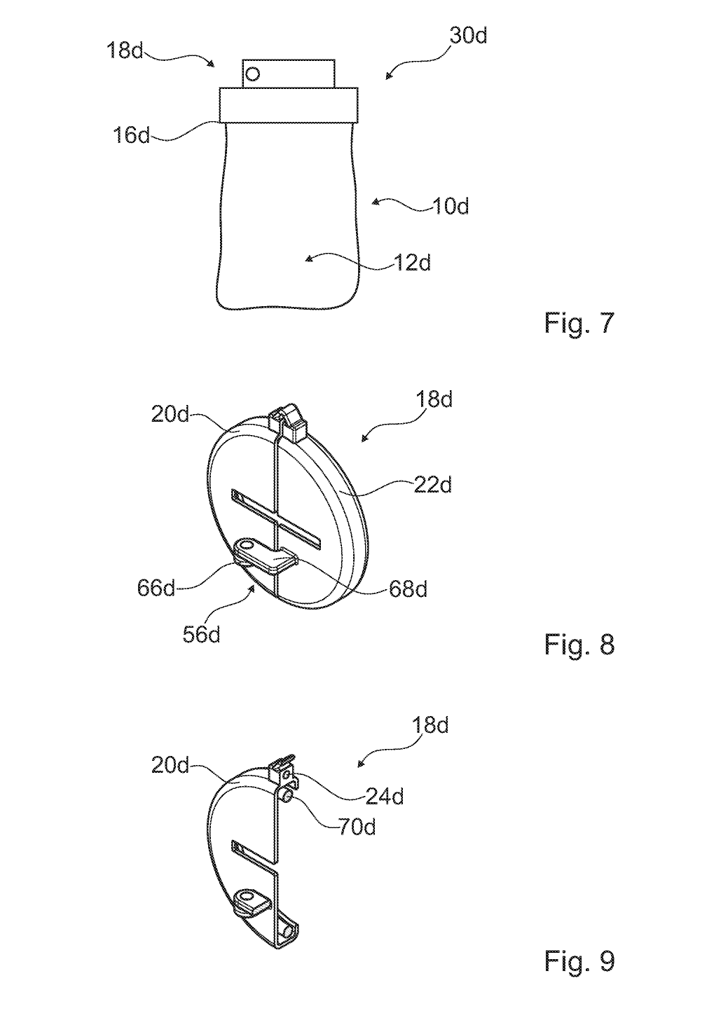

FIG. 7 shows a schematic top view of a fourth life vest bag 30d in a correctly closed state. The fourth life vest bag 30d comprises a receiving unit 10d and a closure unit 18d. The receiving unit 10d comprises a receiving space 12d and an access opening 16d to the receiving space 12d. The closure unit 18d closes the access opening 16d in the correctly closed state. The closure unit 18d is fastened to the receiving unit 10d by means of a clamping connection. The receiving unit 10d comprises a bag 60d which realizes the receiving space 12d. The bag 60d is realized from material in the present case. However, the bag can also be realized from a flexible plastics material, for example from a film.

FIGS. 8 and 9 show a perspective representation or a perspective sectional representation of the closure unit 18d of the fourth life vest bag 30d. The closure unit 18d comprises a first closure element 20d and a second closure element 22d. The first closure element 20d and the second closure element 22d are connected to one another in an articulated manner. The first closure element 20d and the second closure element 22d are realized in a semicircular shape. The first closure element 20d and the second closure element 22d cover the access opening 16d together in the correctly closed state. The first closure element 20d comprises a first protrusion 66d which forms part of a seal 56d. The second closure element 22d comprises a second protrusion 68d which forms part of the seal 56d. In the correctly closed state, the first protrusion 66d and the second protrusion 68d form a common pass-through 52d, through which, for example, a sealing wire of a lead seal or another seal can be run to form a seal.

The closure unit 18d comprises a spring element 24d which is configured for supporting, at least in part, an opening of the access opening 16d. The spring element 24d is realized as a compression spring. In the correctly closed state, the spring element 24d is compressed by the first closure element 20d and the second closure element 22d. On opening, the spring element 24d presses the first closure element 20d and the second closure element 22d apart.

The closure unit 18d comprises a clamp ring 70d. In the correctly closed state, the bag 60d of the receiving unit 10d is clamped between the clamp ring 70d and the closure elements 20d, 22d. For mounting, the bag 60d is passed through an interior of the clamp ring 70d and turned outward over the clamp ring 70d.

In the present case, the closure unit 18d comprises an at least substantially circular cross section. However, other geometries are also conceivable, such as, for example, angular, in particular triangular, rectangular, polygonal or octagonal cross sections or the like being conceivable. It is also conceivable for a first closure element and a second closure element to comprise deviating geometries.

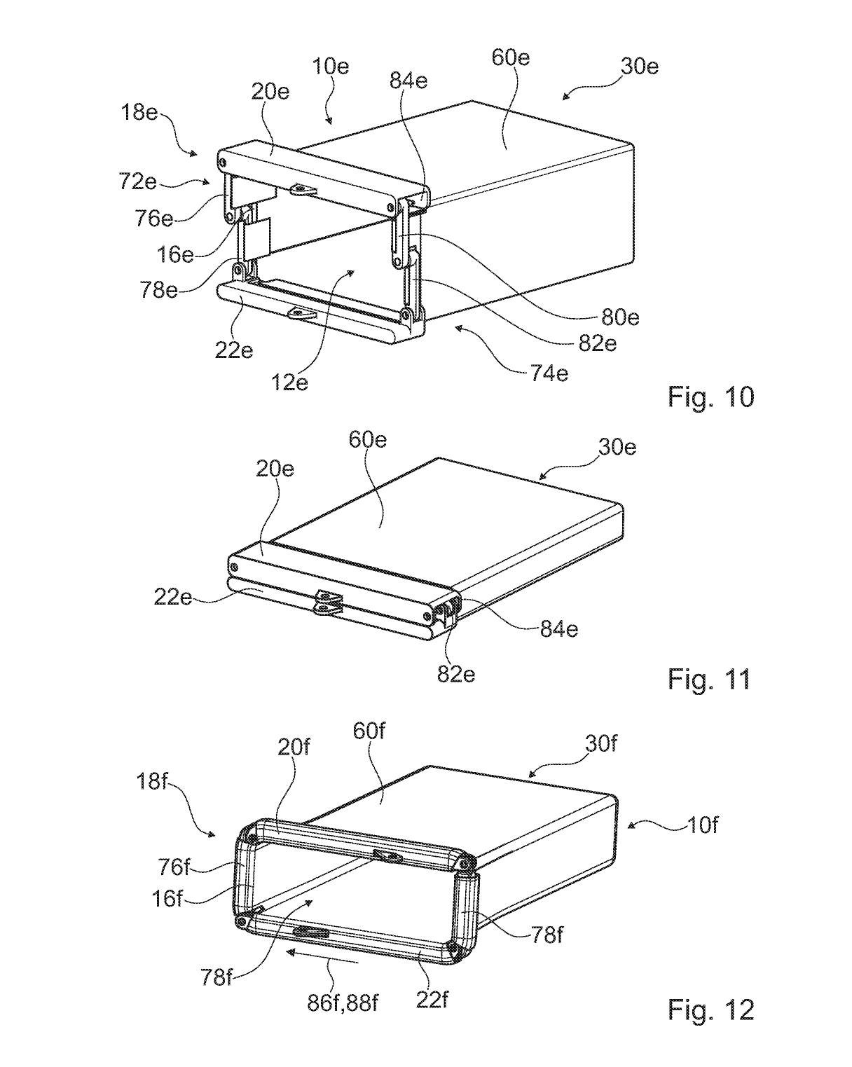

FIG. 10 shows a perspective representation of a fifth life vest bag 30e in an open state. FIG. 11 shows the fifth life vest bag 30e in a correctly closed state. The fifth life vest bag 30e comprises a receiving unit 10e and a closure unit 18e. The receiving unit 10e comprises a receiving space 12e and an access opening 16e to the receiving space 12e. The closure unit 18e closes the access opening 16e in the correctly closed state. The receiving unit 10e comprises a bag 60e which realizes the receiving space 12e. The bag 60e is realized from material in the present case. However, the bag can also be realized from a flexible plastics material, for example from a film.

The closure unit 18e comprises a first closure element 20e and a second closure element 22e. The first closure element 20e and the second closure element 22e are connected to one another in an articulated manner. The first closure element 20e and the second closure element 22e are connected to one another in an articulated manner on two opposite sides 72e, 74e. The first closure element 20e and the second closure element 22e are connected to one another in an articulated manner on the opposite sides 72e, 74e in each case by means of two legs 76e, 78e, 80e, 82e. During closing, the legs 76e, 78e, 80e, 82e fold inward, in particular in the direction of the access opening 16e. The first closure element 20e and the second closure element 22e are supplied parallel to one another during closing. The first closure element 20e comprises a recess 84e, inside which the legs 76e, 78e, 80e, 82e are arranged in the correctly closed state. In the open state, the first closure element 20e, the second closure element 22e and the legs 76e, 78e, 80e, 82e realize a frame about the access opening 16e.

A cross section of the access opening 16e in the correctly closed state deviates from a cross section of the access opening 16e in the open state. The bag 60e is collapsed in the correctly closed state. A volume of the receiving space 12e corresponds in the correctly closed state at least substantially to a volume of a life vest arranged in the receiving space 12e.

FIG. 12 shows a perspective representation of a sixth life vest bag 30f in an open state. The sixth life vest bag 30f comprises a receiving unit 10f and a closure unit 18f. The receiving unit 10f comprises a receiving space 12f and an access opening 16f to the receiving space 12f. The closure unit 18f closes the access opening 16f in a correctly closed state. The receiving unit 10f comprises a bag 60f which realizes the receiving space 12f. The bag 60f is realized from material in the present case. However, the bag can also be realized from a flexible plastics material, for example from a film. A cross section of the access opening 16f in the correctly closed state deviates from a cross section of the access opening 16f in the open state.

The closure unit 18f comprises a first closure element 20f and a second closure element 22f. The first closure element 20f and the second closure element 22f are connected to one another in an articulated manner. The first closure element 20f and the second closure element 22f are connected in each case by means of a leg 76f, 78f on opposite sides 72e, 74f. During closing, the legs 76f, 78f guide the first closure element 20f parallel to the second closure element 22f. During closing, a main extension direction 86f of the first closure element 22f extends parallel to a main extension direction 88f of the second closure element 22f. During closing, the first closure element 20f is displaced laterally relative to the second closure element 22f. The first closure element 20f, the second closure element 22f and the legs 76f, 78f form during closing a parallelogram with interior angles which differ by 90° and which alter in particular at a degree of closing. In general, it is conceivable for a closure unit to comprise a larger number of closure elements which are connected to one another, in particular in an articulated manner. For example, in each case three or in each case four or a different number of closure elements can be connected to one another in an articulated manner. In addition, it is also conceivable for a closure unit to comprise at least one telescopic closure element. For example, in an open state the telescopic closure element can be extended at least in part and/or in a correctly closed state can be pushed together at least in part.

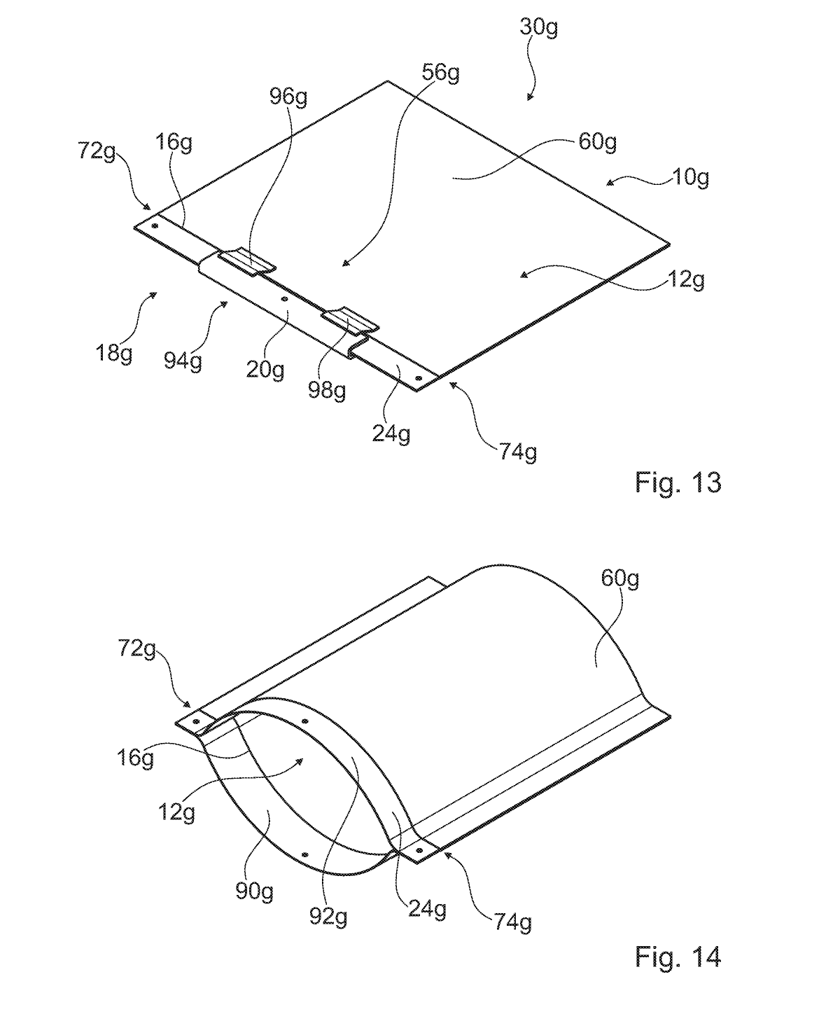

FIG. 13 shows a perspective representation of a seventh life vest bag 30g in a correctly closed state. FIG. 14 shows a perspective representation of the seventh life vest bag 30g in an open state. The seventh life vest bag 30g comprises a receiving unit 10g and a closure unit 18g. The receiving unit 10g comprises a receiving space 12g and an access opening 16g to the receiving space 12g. The closure unit 18g closes the access opening 16g in a correctly closed state. The receiving unit 10g comprises a bag 60g which realizes the receiving space 12g. The bag 60g is realized from plastics material in the present case. A cross section of the access opening 16g in the correctly closed state deviates from a cross section of the access opening 16g in the open state.

The closure unit 18g comprises a spring element 24g which is configured for supporting, at least in part, an opening of the access opening 16g. The spring element 24g is realized as a spring hinge encompassing the access opening 16g at least in part. In the present case, the spring element 24g encompasses the access opening 16g completely. In the present case, the spring element 24g is realized from two spring hinge pieces 90g, 92g which are connected on opposite sides 72g, 74g. The spring element 24g is realized from a metal sheet in the present case. However, it is also conceivable for the spring element to be realized as a spring hinge from a plastics material. In the open state, the spring element 24g realizes a ring-shaped structure which defines the cross section of the access opening 16g in the open state. The spring element 24h is connected to the receiving unit 10g. In the present case, the spring element 24g is connected to the bag 60g of the receiving unit 10g. In particular, the spring element 24g is riveted and/or glued to the receiving unit 10g. However, it is also conceivable for the spring element 24g to be connected integrally to the receiving unit 10g.

The closure unit 18g comprises a closure element 20g. The closure element 20g is realized as a clamp. The closure element 20g encompasses the spring element 24g in the correctly closed state, in particular from a side 94g of the spring element 24g remote from the receiving unit 10g. The closure unit 18g comprises a seal 56g. The seal 56g includes two adhesive seals 96g, 98g which connect the closure element 20g to the receiving element 10g. For opening, the closure element 20g can be pulled down by the spring element 24g. In particular, in this case, the seal 56g is destroyed.

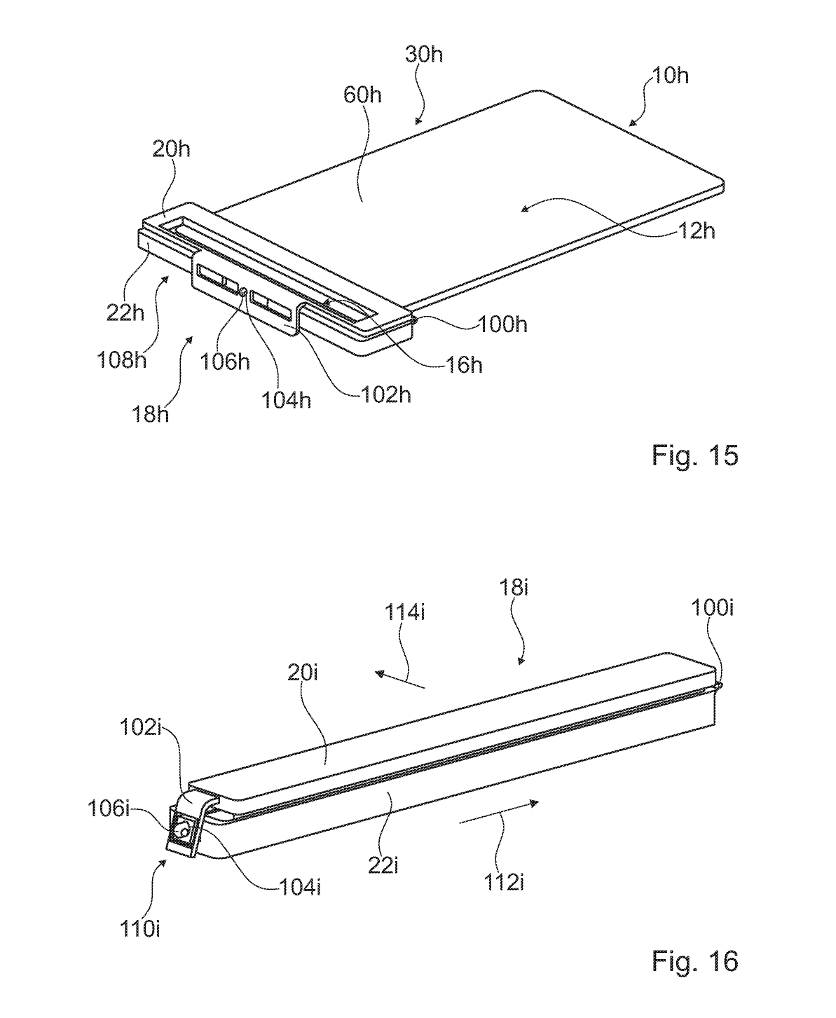

FIG. 15 shows a perspective representation of an eight life vest bag 30h in a correctly closed state. The eighth life vest bag 30h comprises a receiving unit 10h and a closure unit 18h. The receiving unit 10h comprises a receiving space 12h and an access opening 16h to the receiving space 12h. The closure unit 18h closes the access opening 16h in a correctly closed state. The receiving unit 10h comprises a bag 60h which realizes the receiving space 12h. The bag 60h is realized from plastics material in the present case. However, it is also conceivable for the bag to be realized from material. A cross section of the access opening 16h in the correctly closed state deviates from a cross section of the access opening 16h in an open state.

The closure unit 18h comprises a first closure element 20h and a second closure element 22h. The first closure element 20h and the second closure element 22h are connected to one another in an articulated manner. In the present case, the first closure element 20h and the second closure element 22h realize one common film hinge 100h. The first closure element 20h and the second closure element 22h, in the correctly closed state, are connected to one another by means of at least one positive locking connection. In the present case, the first closure element 20h and the second closure element 22h are connected to one another in the correctly closed state by means of a latching connection. The first closure element 20h comprises a tab 102h with a pass-through 104h into which a latching lug 106h of the second closure element 22h latches during closing. The tab 102h is arranged on a front side 108h of the closure unit 18h. The latching lug 106h is arranged on a front side 108h of the closure unit 18h. The front side 108h, in the correctly closed state, is a side of the closure unit 18h remote from the access opening 16h. It is also conceivable for the connecting elements to be connected by means of a further latching connection instead of an articulated connection or in addition thereto. For example, the connecting elements can be connected on two opposite sides each by means of a positive locking connection, in particular a latching connection.

In the correctly closed state, the first closure element 20h and the second closure element 22h clamp the bag 60h of the receiving unit 10h. In the correctly closed state, the closure unit 18h is fastened to the receiving unit 10h by means of a clamping connection. In the open state, the closure 18h can be removed from the bag 60h of the receiving unit 10h. At least a portion of the closure unit 18h is realized so as to be removable from the receiving unit 10h. In the present case, in the open state, the closure unit 18h can be removed from the receiving unit 10h. It is conceivable, in particular, for a closure unit and a receiving unit to be connected to one another, in this case by means of at least one tape and/or one cord.

FIG. 16 shows a perspective representation of a closure unit 18i of a ninth life vest bag. The closure unit 18i comprises a first closure element 20i and a second closure element 22i. The first closure element 20i and the second closure element 22i are connected to one another in an articulated manner. In the present case, the first closure element 20i and the second closure element 22i realize one common film hinge 100i. The first closure element 20i and the second closure element 22i, in a correctly closed state, are connected to one another by means of at least one positive locking connection. In the present case, the first closure element 20i and the second closure element 22i are connected to one another in the correctly closed state by means of a latching connection. The first closure element 20i comprises a tab 102i with a pass-through 104i into which a latching lug 106i of the second closure element 22i latches during closing. The tab 102i is arranged on a side 110i of the closure unit 18i. The latching lug 106i is arranged on the side 110i of the closure unit 18i. The side 110i extends perpendicularly to a main extension direction 112i of the closure unit. The side 110i extends parallel to a life vest removal direction 114i.

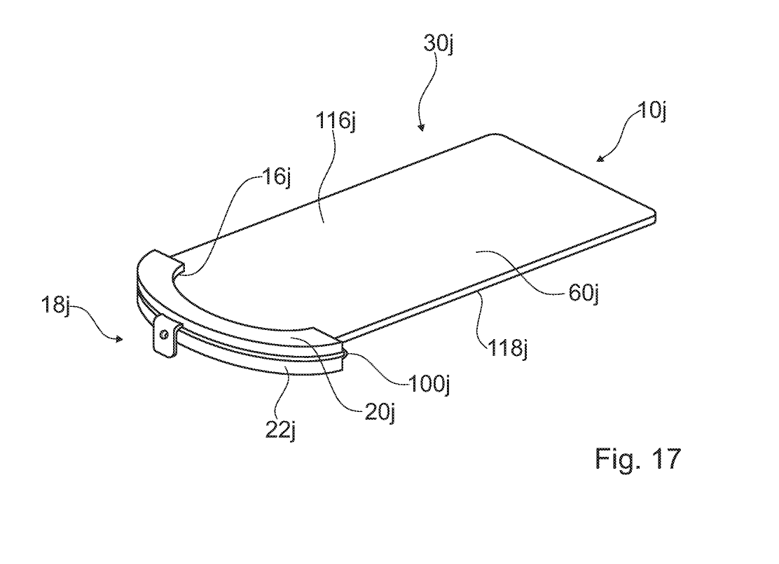

FIG. 17 shows a perspective representation of a tenth life vest bag 30j in a correctly closed state. The tenth life vest bag 30j comprises a receiving unit 10j and a closure unit 18j. The receiving unit 10j comprises a receiving space 12j and an access opening 16j to the receiving space 12j. The closure unit 18j closes the access opening 16j in a correctly closed state. The receiving unit 10j comprises a bag 60j which realizes the receiving space 12j. The bag 60j is realized from plastics material in the present case. However, it is also conceivable for the bag to be realized from material. A cross section of the access opening 16j in the correctly closed state deviates from a cross section of the access opening 16j in an open state.

The closure unit 18j comprises a first closure element 20j and a second closure element 22j. The first closure element 20j and the second closure element 22j are connected to one another in an articulated manner. In the present case, the first closure element 20j and the second closure element 22j realize one common hinge 100j. The first closure element 20j and the second closure element 22j are connected to one another in the correctly closed state by means of at least positive locking connection. In the present case, the first closure element 20j and the second closure element 22j are connected to one another in the correctly closed state by means of a latching connection.

The first closure element 20j and the second closure element 22j are realized in a curved manner, in the present case at least substantially in a semicircular manner. The first closure element 20j is connected to a top side 116j of the bag 60j, in the present case is welded. However, it is also conceivable for a closure element to be sewn to a bag. The second closure element 22j is connected to a bottom side 118j of the bag 60j, in the present case is welded. When the tenth life vest bag 30j is opened, the first closure element 20j and the second closure element 22j realize a ring about the access opening 16j.

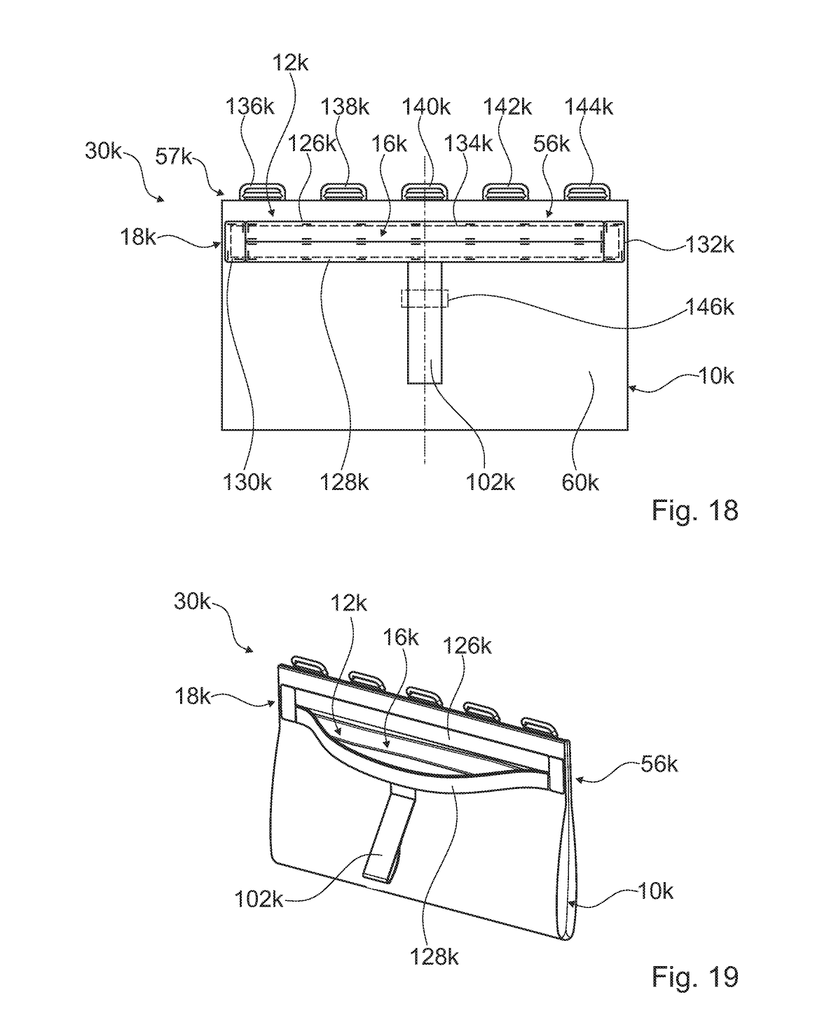

FIGS. 18 and 19 show an eleventh life vest bag 30k. FIG. 18 shows it in a correctly closed state. FIG. 19 shows the eleventh life vest bag 30k in an open state. The eleventh life vest bag 30k comprises a receiving unit 10k and a closure unit 18k. The receiving unit 10k comprises a receiving space 12k and an access opening 16k to the receiving space 12k. The closure unit 18k closes the access opening 16k in the correctly closed state. The life vest bag 30k comprises a mounting unit 57k which is configured for mounting on a passenger seat, in particular on a frame structure of the passenger seat.

The receiving unit 10k comprises a bag 60k which realizes the receiving space 12k. The bag 60k is formed from a fabric. In principle, it is also conceivable for the bag to be formed from another material which appears sensible to the expert. The bag 60k realizes the receiving space 12k in its interior. The bag 60k, in this case, is realized in a rectangular manner. In principle, it is also conceivable for the bag 60k to comprise a different form which appears sensible to the expert. The access opening 16k is provided in the bag 60k. The access opening 16k is formed by a slit in the bag 60k.

The closure unit 18k comprises loop and hook tapes. The loop tape is arranged on a first side of the access opening 16k and the hook tape is arranged on an opposite side of the access opening 16k. In a correctly closed state, hooks of the hook tape are coupled in a positive locking manner with the loop tape. The loop and hook tapes are realized as closure elements of the closure unit 18k. The closure elements which are realized as loop and hook tapes are connected to one another in a positive locking manner in the correctly closed state. The closure elements which are realized as loop and hook tapes are sewn to the receiving unit 10k. The closure unit 18k is connected in one piece to the receiving unit 10k.

The closure unit 18k comprises a seal 56k. The seal 56k comprises multiple adhesive strips 126k, 128k, 130k, 132k. The four adhesive strips 126k, 128k, 130k, 132k of the seal 56k are attached to an outside surface of the bag 60k. The four adhesive strips 126k, 128k, 130k, 132k of the seal 56k encompass the access opening 16k, in this case, on all four sides. The first adhesive strip 126k is attached on the side above the access opening 16k. The first adhesive strip 126k is formed from a hard plastics material strip. The first adhesive strip 126k extends over an entire width of the access opening 16k. The first adhesive strip 126k extends parallel to the access opening 16k. The second adhesive strip 128k is arranged on the side below the access opening 16k. The second adhesive strip 128k is realized from a soft plastics material strip. The second adhesive strip 128k extends over an entire width of the access opening 16k. The second adhesive strip 128k extends parallel to the access opening 16k. The third and fourth adhesive strips 130k, 132k are each arranged at a lateral end of the access opening 16k. The two adhesive strips 130k, 132k delimit the first and the second adhesive strips 126k, 128k, and the access opening 16k at the side. The laterally arranged adhesive strips 130k, 132k are also formed from a hard plastics material strip. In principle, it is also conceivable for all the adhesive strips 126k, 128k, 130k, 132k to be realized from the same material, that is to say, for example, as hard plastics material strips. The seal 56k comprises a sealing strip 134k which additionally closes the access opening 16k in a closed and sealed state. The sealing strip 13k is realized as a thin plastics material strip. The sealing strip 134k is glued onto the adhesive strips 126k, 128k, 130k, 132k. Then sealing strip 134k is realized in a colored manner. In principle, it would also be conceivable, however, for the sealing strips 134k to be realized in a transparent manner. The sealing strip 134k closes the access opening 16k completely. As a result, the life vest bag 30k can be realized in a completely closed manner in an unused state such that nothing is able to be inserted into the life vest bag. As a result, in particular new regulations which prescribe that no objects are able to be inserted into the life vest bag without breaking a seal are able to be maintained. The sealing strip 134k comprises an unsealing function, a clear feature being imaged on the sealing strip 134k after the sealing strip 134k has been removed once from the adhesive strips 126k, 128k, 130k, 132k. A readable message appears on the sealing strip once it has been removed for the first time, such as, for example, in particular the message “VOID” or “Unsealed” which is simple and unambiguous to recognize. The readable message which appears once the sealing strip 134k has been removed is preferably generated during the processing of the sealing strip 134k and is sufficiently known in the prior art.

The life vest bag 30k comprises a tab 102k which is attached to a bottom side of the access opening 16k on the bag 60k. In a closed state, the tab is arranged below the sealing strip 134k. The life vest bag 30k can be opened by pulling on the tab 102k. The access opening 16k closed by the loop and hook tapes is opened by pulling on the tab 102k. In this case, the sealing strip 134k is released at least in part from the adhesive strips 126k, 128k, 130k, 132k. As a result of realizing the adhesive strips 126k, 130k, 132k from a hard plastics material strip, the sealing strip 134k holds particularly well here and the bag 60k is endowed with particularly advantageous dimensional stability. Once the access opening 16k has been torn open by means of the tab 102k, a life vest which is arranged in the receiving space of the life vest bag is able to be removed through the access opening. After the sealing strip 134k has been released once from the bag, that is to say in particular from the adhesive strips 126k, 128k, 130k, 132k, the message that the sealing strip 134 has been released will always be recognizable. As a result of a corresponding design of the life vest bag 30k, a life vest arranged in the life vest bag 30k is particularly easy to remove. For opening the life vest bag 30k, in particular the access opening 16k, just a force of approximately 120 N is necessary to remove the sealing strip 134k and to open the access opening 16k as a result of separating the loop and hook tapes which are arranged there. Without the sealing strip 134k, even just a force of approximately 50 N is necessary to open the access opening 16k of the life vest bag 30k.

The life vest bag 30k comprises a mounting unit 57k. The mounting unit 57k is formed by multiple eyelet elements 136k, 138k, 140k, 142k, 144k, 146k which are arranged fixedly on the bag 60k. The eyelet elements 136k, 138k, 140k, 142k, 144k, 146k are each sewn fixedly to the bag 60k by means of a seam. The mounting unit 57k comprises multiple loop and hook tapes which are connectable to the eyelet elements, by means of which the life vest bag 30k is connected to the aircraft seat. In this case, the life vest bag 30k is arranged by means of the mounting unit 57k directly under a front supporting tube of the aircraft seat. For connection to the aircraft seat, the loop and hook tapes are guided through the eyelet elements 136k, 138k, 140k, 142k, 144k, 146k and a component of the aircraft seat, such as, in particular, around the front supporting tube and are fastened in this manner. In this case, the life vest bag 30k is fastened to the front supporting tube by means of two or three loop and hook tapes, depending on the design of the aircraft seat 10k different eyelet elements 136k, 138k, 140k, 142k, 144k, being able to be used for the connection. As a result of the design with more eyelet elements 136k, 138k, 140k, 142k, 144k, than are actually needed, advantageous flexibility can be provided, by way of which the life belt bag 30k can be connected to the front supporting tube. The eyelet element 146k is arranged on the rear side of the life vest bag 30k at a spacing from the remaining eyelet elements 136k, 138k, 140k, 142k, 144k. The life vest bag 30k is additionally connected to an underside of the aircraft seat by means of the eyelet element 146k by means of a further loop and hook tape. As a result of the additional connection by means of the further eyelet element 146k, the life belt bag 30k is advantageously fixed under the aircraft seat and the life belt bag 30k can be prevented from dangling under the aircraft seat. In this case, the loop and hook tape, which connects the life belt bag 30k to the aircraft seat by means of the further eyelet element 146k, is attached to an electronic box or to another component of the aircraft seat which is arranged under a seat base of the aircraft seat.

### REFERENCE NUMERALS

10 Receiving unit
12 Receiving space
14 Life vest
16 Access opening
18 Closure unit
20 Closure element
21 Closure element
22 Closure element
23 Closure element
24 Spring element
25 Reach-through
26 Reach-through
28 Zipper
30 Life vest bag
32 Passenger seat
34 System
36 Sitting surface
38 Housing
40 Plastics material plate
42 Tab
44 Tab
46 Tab
48 Tab
50 Closing element
52 Pass-through
53 Pass-through
54 Pass-through
55 Pass-through
56 Seal
57 Mounting unit
58 Slit
60 Bag
62 Zipper part
64 Zipper part
66 Protrusion
68 Protrusion
70 Clamp ring
72 Side
74 Side
76 Leg
78 Leg
80 Leg
82 Leg
84 Recess
86 Main extension direction
88 Main extension direction
90 Spring hinge piece
92 Spring hinge piece
94 Side
96 Adhesive seal
98 Adhesive seal
100 Hinge
102 Tab
104 Pass-through
106 Latch lug
108 Front side
110 Side
112 Main extension direction
114 Life vest removal direction
116 Upper side
118 Underside
120 Zipper seal
122 Eyelet
124 Eyelet
126 Adhesive strip
128 Adhesive strip
130 Adhesive strip
132 Adhesive strip
134 Sealing strip
136 Eyelet element
138 Eyelet element
140 Eyelet element
142 Eyelet element
144 Eyelet element

1. A life vest bag, in particular a passenger seat life vest bag, having at least one receiving unit, which comprises at least one receiving space for at least one life vest and at least one access opening to the receiving space, and having at least one closure unit which closes the access opening in at least one correctly closed state.

2. The life vest bag as claimed in claim 1, comprising at least one sealing which is configured to be at least damaged when an object, which comprises a cross section with a cross-sectional area of more than 9 mm by 9 mm, is pushed into the receiving space.

3. The life vest bag as claimed in claim 1, wherein a cross section of the access opening in the correctly closed state deviates from a cross section of the access opening in an open state.

4. The life vest bag as claimed in claim 1, wherein the closure unit comprises at least two closure elements which close the access opening in the correctly closed state.

5. The life vest bag as claimed in claim 4, wherein the closure elements are connected to another in an articulated manner.

6-8. (canceled)

9. The life vest bag as claimed in claim 1, wherein the closure unit is fastened to the receiving unit by means of at least one clamp connection.

10. The life vest bag as claimed in claim 1, wherein at least a portion of the closure unit is realized so as to be removable from the receiving unit.

11-13. (canceled)

14. A system having a life vest bag as claimed in claim 1 and having at least one life vest which is arranged in the receiving space.

15. A passenger seat having a life vest bag as claimed in claim 1.

16. A life vest bag, in particular a passenger seat life vest bag, having at least one receiving unit, which comprises at least one receiving space for at least one life vest and at least one access opening to the receiving space, and having at least one closure unit which closes the access opening in at least one correctly closed state, wherein the closure unit comprises a seal wherein the seal comprises, in the region of the access opening, at least two adhesive strips and at least one sealing strip which is glued onto the adhesive strips.

17. The life vest bag as claimed in claim 16, wherein the adhesive strips of the seal are attached to an outside surface of the bag.

18. The life vest bag as claimed in claim 16, wherein the adhesive strips of the seal encompass the access opening.

19. The life vest bag as claimed in claim 16, wherein the first adhesive strip is formed from a hard plastics material strip and extends over an entire width of the access opening.

20. The life vest bag as claimed in claim 16, wherein the second adhesive strip is realized from a soft plastics material strip and extends over an entire width of the access opening.

21. The life vest bag as claimed in claim 16, wherein laterally arranged adhesive strips are formed from a hard plastics material strip.

22. The life vest bag as claimed in claim 16, the seal comprising a sealing strip which is realized as a thin plastics material strip and additionally closes the access opening in a closed and sealed state, wherein the sealing strip is glued onto the adhesive strips.
